(19) United States
(12) Patent Application Publication
(10) Pub. No.: US 2009/0004549 A1
(43) Pub. Date: Jan. 1, 2009

(54) HIGH POWER FUEL CELL

(75) Inventors: Robert Brian Dopp, Marietta, GA (US); Kimberly McGrath, Newport Beach, CA (US)

Correspondence Address: KNOBBE MARTENS OLSON & BEAR LLP, 2040 MAIN STREET, FOURTEENTH FLOOR, IRVINE, CA, 92614, US

(73) Assignee: Quantumsphere, Inc., Santa Ana, CA (US)

(21) Appl. No.: 12/053,484

(22) Filed: Mar. 21, 2008

Related U.S. Application Data
(60) Provisional application No. 60/896,722, filed on Mar. 23, 2007.

(51) Int. Cl. H01M 4/86; H01M 8/02

(52) U.S. Cl. 429/40; 429/12

(57) ABSTRACT

A device for highly efficient fuel cell reactions is described. The device comprises a porous electrode and a plurality of suspended nanoparticles diffused within the void volume of the electrode when used within an electrolyte, wherein each chamber contains an electrode and electrolyte with suspended nanoparticles therein. When reactive metal particles are diffused into the electrode structure and suspended in electrolyte by gasses, a fluidized bed is established, allowing for improved power generation. Ideally, this device and system can be used to produce high power output.

### BACKGROUND OF THE INVENTION

1. Technical Field

The inventions disclosed herein generally relate to electrochemical production of electricity via fuel cell devices.

2. Related Art

A fuel cell is a device that converts chemical energy directly into electrical energy. They typically operate with higher efficiencies than traditional combustion engines. In addition, emission of greenhouse gasses from fuel cells is reduced or eliminated. The prospect of affordable, clean fuel for stationary and transportation applications are several of the driving forces behind the Hydrogen Economy, wherein the energy infrastructure is based on hydrogen instead of oil. Liquid hydrocarbon fuels, such as methanol, are also advantageous in fuel cells.

Platinum is highly catalytic for hydrogen or hydrocarbon oxidation and oxygen reduction in gas diffusion electrodes for a variety of fuel cells. However, this noble metal is a rapidly depleting non-renewable resource and is consequently expensive. Current price for bulk platinum black is $75.00/gram. The associated cost of a platinum deposited electrode, typically loaded anywhere from 2-8 mg/cm², is widely considered to be a hurdle to widespread commercialization. With the gaining demand for alternative energy sources by consumers, efficient catalysts, new fuel cell electrodes and designs must be discovered to alleviate the demand and expense of platinum. Based on this, considerable effort is being dedicated to find an alternative catalyst which can match or exceed platinum's electrical performance. Method of synthesis of metal nanoparticles has been previously described in U.S. patent application Ser. No. 10/840,409, as well as their use in air cathodes for batteries in U.S. patent application Ser. No. 10/983,993 both of which applications have the same assignee as the present application. The disclosures of these applications are incorporated herein by reference.

### SUMMARY OF THE INVENTION

In one aspect of the invention, a high-surface area electrode is conceived. In one embodiment, the electrode comprises a porous or reticulate metal plate combined with catalytic metal particles, preferably at the nanoscale. The plate preferably includes some void volume to allow infusion of the nanosized metal particles. When immersed within an electrolyte, the metal particles can float freely and can substantially infuse into the porous/reticulate metal plate to create an electrode with extremely high surface area. This electrode can be applied to a variety of devices, including a fuel cell system. Essentially, in such an embodiment, the electrode functions as a fluidized bed. At least one advantage is that the electrode can be operated at very high current (rate), which in turn means that larger amounts of energy can be produced. Typical electrodes have a far lower surface area and thus cannot provide increased power density. Other advantages may include, depending upon the configuration, circumstances, and environment, the ability to scale the electrode to a wide variety of sizes, higher power, and the ability to minimize agglomeration by using nanosized particles.

In another embodiment of the invention, a new electrochemical device is contemplated, preferably a fuel cell device. Unlike traditional fuel cells, one embodiment of the inventive electrochemical device system may be oriented horizontally rather than vertically. With such an arrangement, air/oxygen may be moved through the lower (cathode) chamber, and enter a catalytic layer through a porous hydrophobic film where it reacts with water and electrons being consumed and hydroxyl ions generated on the lower electrode. Excess oxygen may be re-circulated back into the system. Hydroxyl ions from the reaction can move through a separator membrane to the upper (anode) chamber, where they recombine with hydrogen gas to produce water and electrons. Contemporaneously, the upper chamber electrode is consuming hydrogen gas. Hydrogen gas is circulated through the upper chamber through a diffuser, and because hydrogen gas is less dense than the electrolyte, the unreacted hydrogen may bubble upwards and can then be removed from the system to be re-circulated back through the diffuser. Preferably, a fluidized bed is established using hydrogen gas as the fluidizer in the upper chamber employing catalytic nanoparticles. At least some advantages include, depending upon the configuration, circumstances, and environment, (i) pumping only gasses means much lower parasitic losses than if pumping fluids; (ii) there is no need for a gas separator in the upper chamber; gas freely moves upward because it is less dense, (iii) all excess hydrogen and oxygen gas can be re-circulated back into the system, minimizing reactant loss and increasing efficiency, and (iv) elimination of precious metal catalysts.

In yet another aspect of the invention, a fluidized bed electrolyzer can also be established in a vertical orientation. This device may consist of a corrosion resistant container that houses a cylindrical separator. Porous anode and cathode electrodes would be disposed on the outer and inner circumference of the separator, respectively. The inner chamber would be filled with electrolyte and preferably contain a plurality of reactive metal nanoparticles. These reactive metal nanoparticles establish a fluidized bed in the anode chamber. The cathode would contain a hydrophobic sheet through which oxygen could flow to sustain the electron consuming reaction. The hydroxyl ions would migrate through the vertical, cylindrical separator to react on the anodic current collector with the anolyte and catalyzed by the fluidized catalyst particles. At least some advantages of this configuration include, (i) ease of keeping hydrogen and oxygen gasses separated, (ii) ease of controlling temperature and pressure, (iii) simple design, (iv) less expensive per unit of electricity produced, and (v) elimination of precious metal catalysts. Preferably, a number of vertical orientation electrolyzers are interconnected to function as an electrolyzer stack.

In another embodiment of the inventive electrochemical device system air/oxygen may be moved through one (cathode) chamber, with electrons being consumed and hydroxyl ions generated on that electrode. Excess oxygen may be re-circulated back into the system. Preferably, a fluidized bed is established using oxygen gas as the fluidizer in this cathodic chamber employing catalytic nanoparticles. Hydroxyl ions from the reaction can diffuse through a separator membrane to an adjacent (anode) chamber, where they recombine with hydrogen gas in a current collecting surface in the presence of catalytic particles and electrolyte to produce water and electrons. Contemporaneously, this anode chamber electrode hydrogen gas is circulated through this chamber through a diffuser, and can be re-circulated back through the diffuser. Preferably, a fluidized bed is established using hydrogen gas as the fluidizer in this anodic chamber employing catalytic nanoparticles. At least some advantages include, depending upon the configuration, circumstances, and environment, (i) circulating gasses is lower energy than pumping liquids, so there will be less parasitic losses; (ii) there is no need for an external gas separator, (iii) all excess hydrogen and oxygen gas can be re-circulated back into the system, minimizing reactant loss and increasing efficiency, and (iv) elimination of precious metal catalysts.

In another aspect of the invention, the cathode electrode used in the fuel cell is described in U.S. patent pending application Ser. No. 11/482290.

### BRIEF DESCRIPTION OF THE DRAWINGS

FIG. 1 is a schematic of a typical fuel cell.

FIG. 2 is a fuel cell described in some of the preferred embodiments.

FIG. 3 is a fuel cell described in some of the preferred embodiments.

The features mentioned above in the summary of the invention, along with other features of the inventions disclosed herein, are described below with reference to the drawings of the preferred embodiments. The illustrated embodiments in the figures listed below are intended to illustrate, but not to limit the inventions.

### DETAILED DESCRIPTION OF SOME PREFERRED EMBODIMENTS

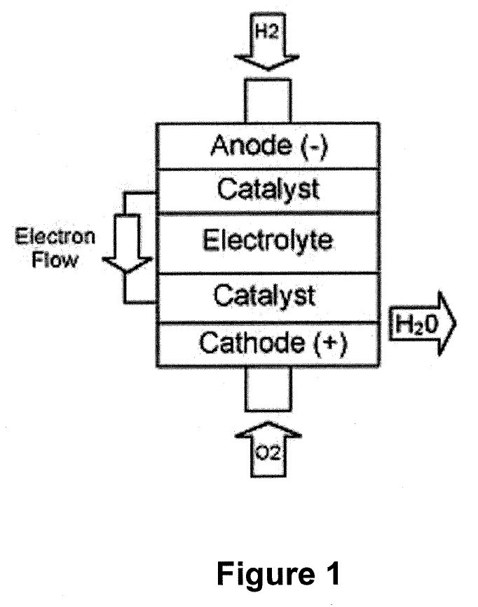

FIG. 1 illustrates a traditional fuel cell system. The electrodes are typically oriented in a vertical fashion and are substantially solid. Oxygen and hydrogen gasses are applied to the cathode and anode electrodes, respectively. Electrodes are typically solid metal or electrodeposited metal with relatively low surface area.

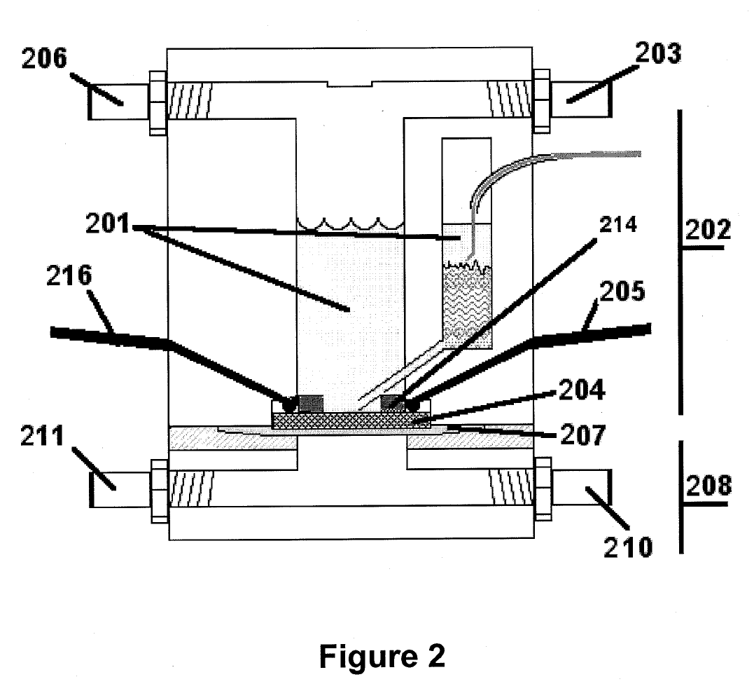

Referring to FIG. 2, one embodiment of an inventive fuel cell configured to generate electricity from hydrogen and oxygen can be described. Electrolyte 201, such as aqueous potassium hydroxide (KOH) may be placed in a first chamber 202 via inlet port 203. When hydroxyl ions (OH—) come into contact with anode electrode 204, electrons and water are produced by H₂+2OH⁻→2H2O+2e−. Electrons move through circuit to the cathode via electrical circuit 205. Because hydrogen gas is less dense than the electrolyte, it rises and leaves via port 206 to be re-circulated back into the upper chamber through diffuser 214. In a second chamber 208, oxygen is circulated parallel to anode electrode and over the cathode assembly 207, which consists of a hydrophobic layer, current collector catalytically active mass and separator via inlet port 211 and outlet port 210. In a preferred operative mode of at least one system embodiment, the system is oriented such that the first chamber 202 is positioned above the second chamber 208. Such an arrangement provides some advantages as discussed herein. It is contemplated, however, that another embodiment may comprise a system that is usefully oriented in such a manner that the first chamber is horizontally displaced relative to the second chamber, either in a side-by-side arrangement, or at some angle between vertical and horizontal.

When electricity is applied to cathode electrode 207 via electrical contact 212, and air is circulated through the system, hydroxyl ions (OH⁻) are produced pursuant to the following general reaction: 1/2O₂+H₂O+2e−→2OH⁻. Excess oxygen moves through the system and can be circulated back into the cell to decrease reactant loss.

For some system measurements, a side chamber containing separator mat 214 is filled with electrolyte 201, and reference electrode 215 is placed to measure electrochemical potential versus the upper chamber. Additionally, working reference electrode 216 is placed in contact with electrode 204.

In some of the preferred embodiments, the upper chamber features both an inlet and outlet port. One of the ports allows the removal and recirculation of hydrogen gas in the system, and the other allows for direct injection of new electrolyte or new catalyst. This feature allows for both simple cleaning and replenishment or replacement of catalyst and reactants.

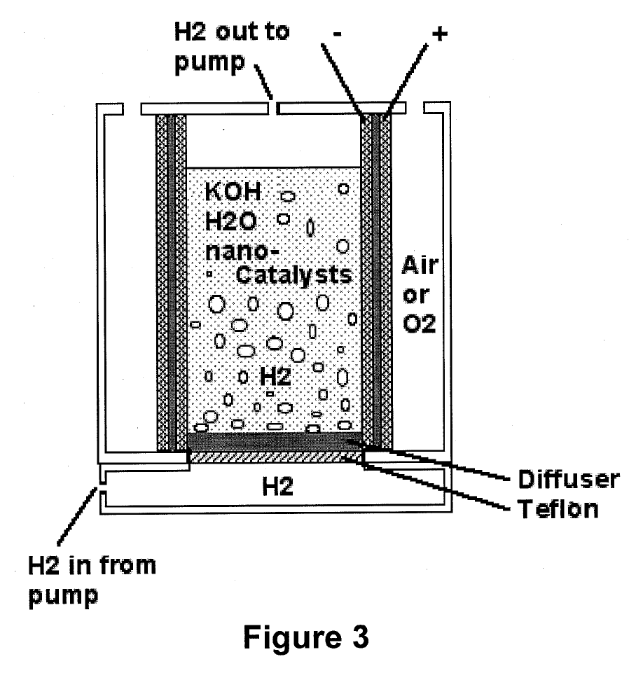

A vertical design is also conceived, as shown in FIG. 3. The hydrogen would need to be circulated out the top and back in the bottom. The air also needs circulation, but if the outer wall were perforated, then it may work well in a static condition. In this design, multiple tubes could be connected for increased power output.

Some of the preferred embodiments detail an increased available reaction surface through the use of porous electrodes. The electrodes can be prepared of networking metal particles, for example reticulate nickel or nickel foam. In other embodiments, the electrodes may be sintered metal plates, prepared such that the electrode is highly porous with a relatively large void volume. The electrodes are preferably prepared from metals, preferably selected from the group of metals from groups 3-16, and the lanthanide series. More preferably, the metals are transition metals, mixtures thereof, and alloys thereof and their respective oxides. Most preferably, the metal or metals are selected from the group consisting of nickel, iron, manganese, cobalt, tin, and silver, or combinations, alloys, and oxides thereof for the cathode chamber and Nickel, silver, cobalt, tungsten, FeWosub3 and WCosub12 for anodic catalysts.

An aspect of at least some of the embodiments in this invention includes the realization that a reticulate or porous electrode's surface area can be increased significantly through the use of free moving reactive metal particles within the electrolyte. The electrolyte serves as both an ionic conductor and medium for the particles. Because of the reticulate or porous nature of the electrode, reactive metal particles can infuse into the electrode surface and become diffuse throughout the void volumes in the electrode. Preferably, the particles are less than one micron in effective diameter, and most preferably less than 100 nanometers in diameter. Most preferably, the reactive metal particles are less than 50 nm in diameter such that substantial portion can infuse into the electrode. Larger particles tend to agglomerate to the extent that the void volume within the electrode can no longer accommodate their size. This results in a significant loss in efficiency.

Additionally, reactive surface area is increased by order of magnitude by operation with catalytic nanoparticles in the fluidized bed. In addition to the surface area of the porous or reticulate electrode, and nanoparticles infused into the electrode, the system capitalizes on the additional surface area of the fluidized catalytic nanoparticles. The increased catalytic behavior of the reactive metal nanoparticles, compared to the surface of the metal substrate alone, is high due to the very large number of atoms on the surface of the nanoparticles. By way of demonstration, consider a 3 nanometer nickel particle as a tiny sphere. Such a sphere would have 384 atoms on its surface and 530 within its interior, of the 914 atoms in total. This means that 58% of the nanoparticles would have the energy of the bulk material and 42% would have higher energy due to the absence of neighboring atoms. Nickel atoms in the bulk material have about 12 nearest neighbors while those on the surface have nine or fewer. A 3 micron sphere of nickel would have 455 million atoms on the surface of the sphere, 913 billion in the low energy and isolated interior of the sphere for a total of nearly one trillion atoms. That means that only 0.05% of the atoms are on the surface of the 3 micron-sized material compared to the 42% of the atoms at the surface of the 3-nanometer nickel particles.

The reactive metal particles can be formed through any known manufacturing technique, including, for example, but without limitation, ball milling, precipitation, plasma torch synthesis, combustion flame, exploding wires, spark erosion, ion collision, laser ablation, electron beam evaporation, and vaporization-quenching techniques such as joule heating.

Another possible technique includes feeding a material onto a heater element so as to vaporize the material in a well-controlled dynamic environment. Such technique desirably includes allowing the material vapor to flow upwardly from the heater element in a substantially laminar manner under free convection, injecting a flow of cooling gas upwardly from a position below the heater element, preferably parallel to and into contact with the upward flow of the vaporized material and at the same velocity as the vaporized material, allowing the cooling gas and vaporized material to rise and mix sufficiently long enough to allow nano-scale particles of the material to condense out of the vapor, and drawing the mixed flow of cooling gas and nano-scale particles with a vacuum into a storage chamber. Such a process is described more fully in U.S. patent Ser. No. 10/840,109, filed May 6, 2004, the entire contents of which is hereby expressly incorporated by reference.

The chemical kinetics of catalysts generally depends on the reaction of surface atoms. Having more surface atoms available will increase the rate of many chemical reactions such as combustion, electrochemical oxidation and reduction reactions, and adsorption. Extremely short electron diffusion paths, (for example, 6 atoms from the particle center to the edge in 3 nanometer particles) allow for fast transport of electrons through and into the particles for other processes. These properties give nanoparticles unique characteristics that are unlike those of corresponding conventional (micron and larger) materials. The high percentage of surface atoms enhances galvanic events such as the splitting of hydrogen or methanol to generate electrons, or the oxygen reduction reaction.

The reactive metal particles referenced herein are preferably selected from the group of metals from groups 3-16, and the lanthanide series. More preferably, the metals are transition metals, mixtures thereof, and alloys thereof and their respective oxides. Most preferably, the metal or metals are selected from the group consisting of nickel, iron, manganese, cobalt, tin, tungsten and silver, or combinations, alloys, and oxides thereof. The nanoparticles may be the same as, substantially the same, or entirely different materials from those chosen for the electrode. Additionally, the nanoparticles may comprise a metal core and an oxide shell having a thickness in the range from 5 to 100% of the total particle composition, wherein the metal core may be an alloy.

The foregoing description is that of preferred embodiments having certain features, aspects, and advantages in accordance with the present inventions. Various changes and modifications also may be made to the above-described embodiments without departing from the spirit and scope of the inventions.

What is claimed is:

1. A device suitable for use in at least one fuel cell application, the device comprising a first component and a second component, the first component comprising a metal having substantial void volume and where said first component is at least partially exposed to a reaction medium during use, the second component comprising a plurality of reactive metal nanoparticles suspended in the reaction medium and substantially diffused through the first component when the device is in use.

2. The device of claim 0, wherein at least a substantial portion of the plurality of reactive metal particles comprises particles have an effective diameter of less than about 100 nm.

3. The device of claim 0, wherein at least a portion of the reactive metal particles comprise nanoparticles having an oxide shell.

4. The device of claim 0, wherein the plurality of reactive metal particles comprise one or more of the metals from groups 3-16, lanthanides, combinations thereof, and alloys thereof.

5. The device of claim 0, wherein the first component is a sintered porous metal plate.

6. The device of claim 0, wherein the first component is a reticulate metal plate.

7. The device of claim 0, wherein the first component comprises one or more of the metals from groups 3-16, lanthanides, combinations thereof, and alloys thereof.

8. The device of claim 1, wherein the reaction medium is an alkaline electrolyte.

9. The device of claim 1, wherein the reaction medium is an acidic electrolyte.

10. The device of claim 1, wherein the device is configured to generate electricity from liquid or gaseous fuels.

11. The device of claim 10, wherein the fuel is hydrogen.

12. The device of claim 10, wherein the fuel is oxygen.

13. The device of claim 10, wherein the fuel is ammonia.

14. The device of claim 10, wherein the fuel is a lower alcohol, ester, ether, or carbonate.
